(19) United States
(12) Patent Application Publication
(10) Pub. No.: US 2008/0256136 A1
(43) Pub. Date: Oct. 16, 2008

(54) Techniques and tools for managing attributes of media content

(76) Inventor: Jerremy Holland, Los Altos Hills, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/060,010

(22) Filed: Mar. 31, 2008

Related U.S. Application Data
(60) Provisional application No. 60/911,884, filed on Apr. 14, 2007.

(51) Int. Cl. G06F 17/30; G06F 3/048

(52) U.S. Cl. 707/200; 715/764; 707/E17.009

(57) ABSTRACT

Methods, graphical user interfaces, computer apparatus and computer readable medium for managing attributes (or properties) for media content are disclosed. In accordance with one embodiment, a user of a computing device can utilize the methods, graphical user interfaces, computer apparatus, and computer readable medium to copy attributes from one digital media asset to one or more other digital media assets. The digital media assets can be audio, video or graphical.

### CROSS-REFERENCE TO RELATED APPLICATION

This application claims priority to U.S. Provisional Patent Application No. 60/911,884, filed Apr. 14, 2007, entitled “TECHNIQUES AND TOOLS FOR MANAGING ATTRIBUTES OF MEDIA CONTENT”, which is hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

In the course of producing a video, such as a movie, it is common for audio engineers (or sound engineer) to add audio properties (or characteristics) to audio clips (or segments). The audio clips can be part of one or more audio tracks to a video track. This task can be referred to as audio production. It takes a substantial effort to configure various audio properties to an audio clip. Examples of some audio properties include equalization, reverberation, voice matching, room sounds, etc. There are software programs that assist audio engineers with placing and editing audio clips, including configuring audio properties for the video clips. One example of an existing software program for audio editing/production application is “Soundtrack Pro” available from Apple Inc. of Cupertino, Calif. Even so, there can be numerous attributes and configuring attributes for various audio clips can require significant user effort. It is also difficult and time consuming for a user to manually configure different audio clips to have the same or similar attributes. Hence, there is a need to provide improved approaches to establishing attributes for audio clips.

### SUMMARY OF THE INVENTION

The invention pertains to methods, graphical user interfaces, computer apparatus and computer readable medium for managing attributes for media content. In accordance with one embodiment, a user of a computing device can utilize the methods, graphical user interfaces, computer apparatus, and computer readable medium to copy attributes from one digital media asset to one or more other digital media assets. The digital media assets can be audio, video or graphical.

The invention can be implemented in numerous ways, including as a method, system, device, apparatus (including graphical user interface), or computer readable medium. Several embodiments of the invention are discussed below.

As a method for applying attributes to a digital media asset, one embodiment of the invention can include at least: receiving a first user request to copy a determined set of attributes associated with a first digital media asset; copying the determined set of attributes from the first digital media asset to memory storage in response to the received first user request; receiving a second user request to apply at least one of the attributes within the determined set of attributes to a second digital media asset; and applying the at least one of the attributes within the determined set of attributes stored in the memory storage to the second digital media asset in response to the received second user request.

As a method for applying attributes to a media segment, one embodiment of the invention can include at least: displaying a lift tool for lifting attributes from digital media segments; determining a set of attributes to be lifted; receiving a selection of a source media segment; lifting attributes from the selected source media segment in accordance with the determined set of attributes that are enabled; subsequently displaying a stamp tool; receiving a selection of a destination media segment; and applying the lifted attributes to the destination media segment.

As a computing device, one embodiment of the invention includes at least: an user input device configured to receive user inputs, a memory storage device configured to access store computer program code, and a processing device configured to execute the computer program code stored in the memory storage device. The stored computer program code including at least: computer program code for determining that a user input pertains to a first user request to copy a determined set of attributes associated with a first digital media asset; computer program code for copying the determined set of attributes from the first digital media asset to said memory storage device in response to the first user request; computer program code for receiving a second user request to apply at least one of the attributes within the determined set of attributes to a second digital media asset; and computer program code for applying the at least one of the attributes within the determined set of attributes stored in said memory storage device to the second digital media asset in response to the second user request.

As a graphical user interface for display on a display associated with a computing device, one embodiment of the invention includes at least: a name for a set of audio properties; a listing of each of the audio properties; a disable control for each of the audio properties; and an apply control for initiating application of those of the audio properties that are not disabled to an audio segment.

As a computer readable medium including at least executable computer program code tangibly stored thereon for applying attributes to a digital media asset, one embodiment of the invention includes at least: computer program code for receiving a request to copy a determined set of attributes associated with a first digital media asset; computer program code for copying attributes from the first digital media asset in response to the received request; computer program code for receiving a request to apply at least one of the copied attributes to a second digital media asset; and computer program code for applying the at least one of the copied attributes to the second digital media asset in response to the received request.

As a computer readable storage medium including at least executable computer program code tangibly stored thereon for applying attributes to a digital asset segment, one embodiment of the invention includes at least: computer program code for displaying a first tool for capturing attributes from digital asset segments; computer program code for determining a set of attributes to be captured; computer program code for receiving a selection of a source digital asset segment; computer program code for capturing attributes from the selected source digital asset segment in accordance with the determined set of attributes that are enabled; computer program code for subsequently displaying a second tool; computer program code for receiving a selection of a destination digital asset segment; and computer program code for applying the captured attributes to the destination digital asset segment.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a diagram of a lift and stamp tool according to one embodiment of the invention.

FIG. 1B is a diagram of a lift and stamp tool according to another embodiment of the invention.

FIG. 2 is a flow diagram of a lift attribute process according to one embodiment of the invention.

FIGS. 3A and 3B are flow diagrams of a stamp tool process according to one embodiment of the invention.

FIG. 4 illustrates an exemplary sound palette dialog according to one embodiment of the invention.

FIG. 5 is an exemplary sound palette dialog according to one embodiment of the invention.

FIG. 6 is an exemplary sound palette window according to one embodiment of the invention.

FIG. 7 shows an exemplary computer system suitable for use with the invention.

### DETAILED DESCRIPTION OF THE INVENTION

The invention pertains to methods, graphical user interfaces, computer apparatus and computer readable medium for managing attributes (or properties) for media content. In accordance with one embodiment, a user of a computing device can utilize the methods, graphical user interfaces, computer apparatus, and computer readable medium to copy attributes from one digital media asset to one or more other digital media assets. The digital media assets can be audio, video or graphical. The invention is described below with reference to digital audio assets.

According to one embodiment of the invention, attributes can be copied from one audio clip to one or more other audio clips. A particular source audio clip can have inherent attributes as well as attributes provided through user interaction with an audio production application. Still further, the particular source audio clip can have attributes pertaining to analysis results. Regardless of where the attributes arose from, the attributes can be captured in a user-friendly manner and then later applied to one or more other audio clips, thereby enabling a user to easily replicate attributes from one audio clip to other audio clips.

In one embodiment, the invention can be implemented by lift and stamp tools. A lift tool is able to lift attributes from an audio clip. The attributes can pertain to audio characteristics, audio filters and/or metadata pertaining to the audio clip. Once the attributes have been lifted from an existing audio clip, a stamp tool can be utilized to apply such attributes to one or more other audio clips.

According to one embodiment, once attributes are lifted by the lift tool, the attributes can be stored as a template (or preset) such that they are stored and available for subsequent use (such as applying the attributes to various other audio clips). In another embodiment, the lifted attributes can be enabled or disabled with respect to particular attributes. In still another embodiment, the template (or preset) can be named and a thumbnail image can be provided to represent the template (or preset). Multiple templates (or presets) can be saved and subsequently selected and/or edited.

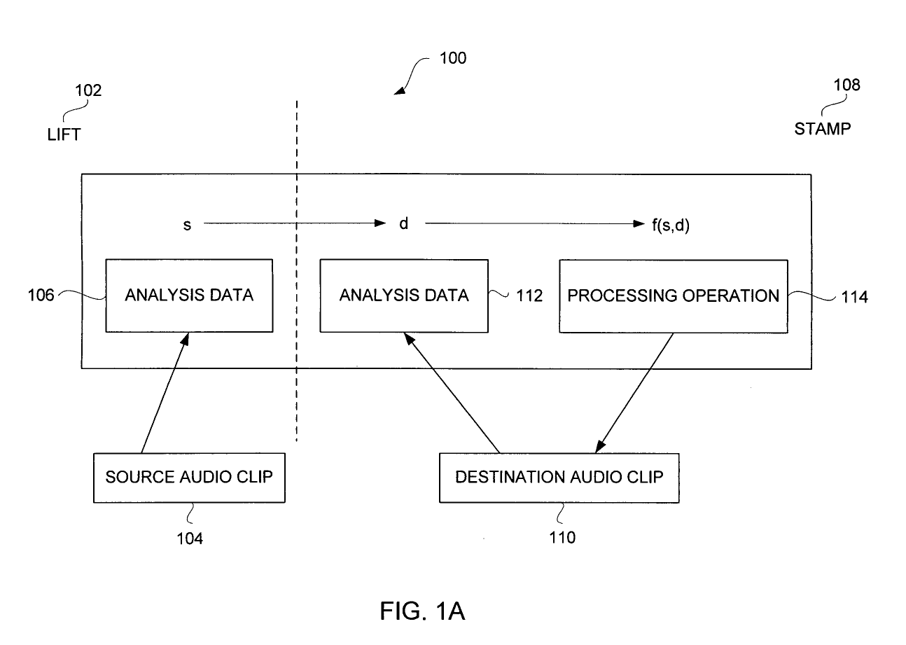

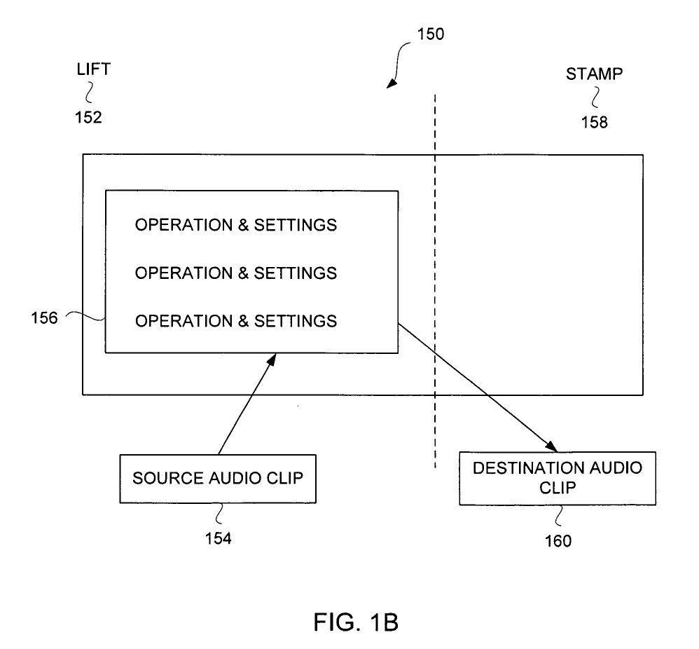

Embodiments of the invention are discussed below with reference to FIGS. 1A-7. However, those skilled in the art will readily appreciate that the detailed description given herein with respect to these figures is for explanatory purposes as the invention extends beyond these limited embodiments.

FIG. 1A is a diagram of a lift and stamp tool 100 according to one embodiment of the invention. The left side of the diagram for the lift and stamp tool 100 pertains to a lift operation 102. The lift operation 102 receives the attributes of a source audio clip 104. The attributes being lifted from the source audio clip 104 can be categorized as analysis items or process items. The process items can correspond to actions (e.g., processing operations/effects) applied to a source audio clip. The analysis items are those attributes that involve analysis of a source audio clip. Analysis data 106 can be obtained when lifting the analysis-type attributes from the source audio clip 104.

Subsequently, a stamp tool 108 is utilized to apply the lifted attributes to a destination audio clip 110. In doing so, the stamp tool 108 may perform analysis on the destination audio clip 110, such as when the analysis-type attributes are to be applied. Then, one or more processing operations can be performed on the destination audio clip 110. The processing operations 114 can, in one embodiment, be a function of the analysis data 106 of the source audio clip 104 as well as the analysis data 112 of the destination audio clip 110. In a general sense, by lifting and stamping attributes from one audio clip to another, the destination audio clip 110 is modified so as to sound more like the source audio clip 104. For example, if the attributes associated with the source audio clip 104 apply a significant amount of reverberation such as associated with a stadium environment, the destination audio clip 110 can be processed to introduce a similar degree of reverberation.

Process-type attributes pertain to effects of processing that are obtained from a source audio clip. Some examples of process-type attributes can include: equalization, compression, reverberation, level adjust, etc.

In general, the analysis-type attribute can provide equalization matching, voice matching, level matching or ambience matching for the source audio clip 104. Examples of some analysis-type attributes can include: Equalization Print (analyze equalization properties of the source audio clip), Voice Signature (for voice-matching/voice morphing dialog), Room Tone (analyze clip and generate a room tone buffer), Reverb (analyze reverb characteristics of clip and choose reverb settings to match), Microphone Print (analyze the sound of a microphone), or Level/Volume (analyze the level/volume of an attribute of the source audio clip). Typically, for analysis-type attributes, the source audio clip is analyzed and the results of that analysis (e.g. an equalization curve, a buffer of audio, algorithm specific analysis data, etc.) is stored as the analysis data 106. When an analysis operation is applied to a destination audio clip, it typically involves at least a two-step process. Namely, first, analyzing the destination audio clip to obtain the analysis data 112, then performing some function (f) on the analysis data from the source audio clip and on the analysis data from the destination audio clip to derive the processing operation 114 (e.g., function/operation/sound processing, etc.) to be applied to the destination audio clip.

Besides the process-type attributes and the analysis-type attributes, the attributes (or properties) can also include administrative attributes. The administrative attributes can, for example, include metadata associated with a audio clip or presentation settings which can effect how the audio clip is presented in a timeline, project, or final composition.

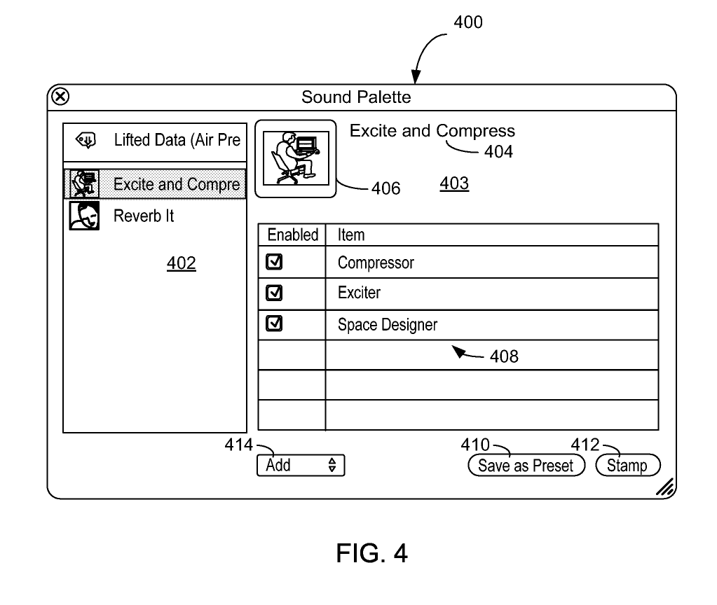

FIG. 1B is a diagram of a lift and stamp tool 150 according to another embodiment of the invention. The left side of the diagram for the lift and stamp tool 150 pertains to a lift operation 152. The lift operation 152 receives the attributes of a source audio clip 154. The attributes being lifted from the source audio clip 154 can be categorized as analysis items or process items. In this embodiment, the attributes can be process items. The process items are actions that have been performed on the source audio clip 154. Hence, when lifting the process-type attributes from the source audio clip 154 the actions are obtained. Knowing the actions, a set of one or more operations and associated settings are determined. For example, as shown in FIG. 4, in one embodiment, the actions can be Compressor, Exciter and Space Designer. For these actions, the set of one or more operations and associated settings can be determined. For example, one operation is a compressor and its settings could be ratio=1.10, level=0 db, etc.). Subsequently, a stamp tool 158 is utilized to apply the lifted attributes to a destination audio clip 160. In doing so, the stamp tool 108 causes the set of one or more operations (using its associated settings) to be performed on the destination audio clip 160.

In a general sense, in one embodiment, by lifting and stamping attributes from one audio clip to another, a destination audio clip can be modified so as to sound more like a source audio clip. For example, if the attributes associated with the source audio clip apply a significant amount of reverberation such as associated with a stadium environment, the destination audio clip can be processed to introduce a similar degree of reverberation.

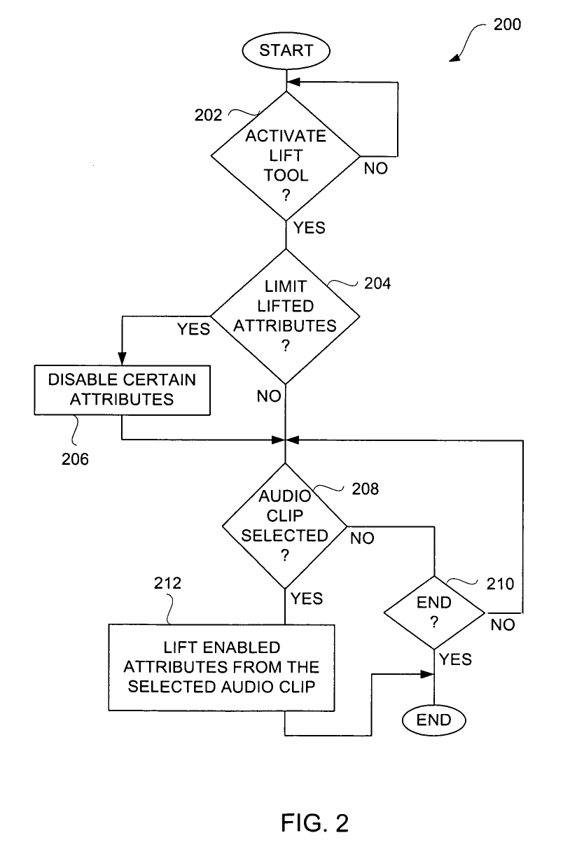

FIG. 2 is a flow diagram of a lift attribute process 200 according to one embodiment of the invention. The lift attribute process is, for example, processing performed by a computing device. For example, the lift attribute process 200 can be associated with an audio production software application that utilizes audio clips in assembling audio to be utilized with a video track.

The lift attribute process 200 can begin with a decision 202 that determines whether a lift tool has been activated. The lift tool is a graphical user interface that assists a user in utilizing the lift attribute process 200 with respect to one or more audio clips. When the decision 202 determines that the lift tool has not been activated, the attribute lift process 200 awaits activation of the lift tool. Once the decision 202 determines that the lift tool has been activated, a decision 204 can determine whether lifted attributes are to be limited. When the decision 204 determines that such lift attributes are to be limited, certain attributes are disabled 206. For example, a user can select to disable certain of those of the attributes that are able to be lifted. Since some attributes can require processing of the audio clip, it can be advantageous to disable those attributes that are not to be lifted. A user interface control can be used to assist a user with enabling or disabling attributes that are to be lifted.

Following the block 206 as well as directly following the decision 204 when lifted attributes are not being limited, a decision 208 determines whether an audio clip has been selected. Here, the user of the lift tool can select an audio clip from which the attributes are to be lifted. When the decision 208 determines that an audio clip has not been selected, a decision 210 can determine whether the attribute lift process 200 should end. When the decision 210 determines that the lift attribute process 200 should not end, then the lift attribute process 200 returns to repeat the decision 208 and subsequent blocks. When the decision 208 determines that audio clip has been selected, the enabled attributes can be lifted 212 from the selected audio clip. Following the block 212 as well as directly following the decision 210 when the lift attribute process 200 is to end, the lift attribute process 200 can end.

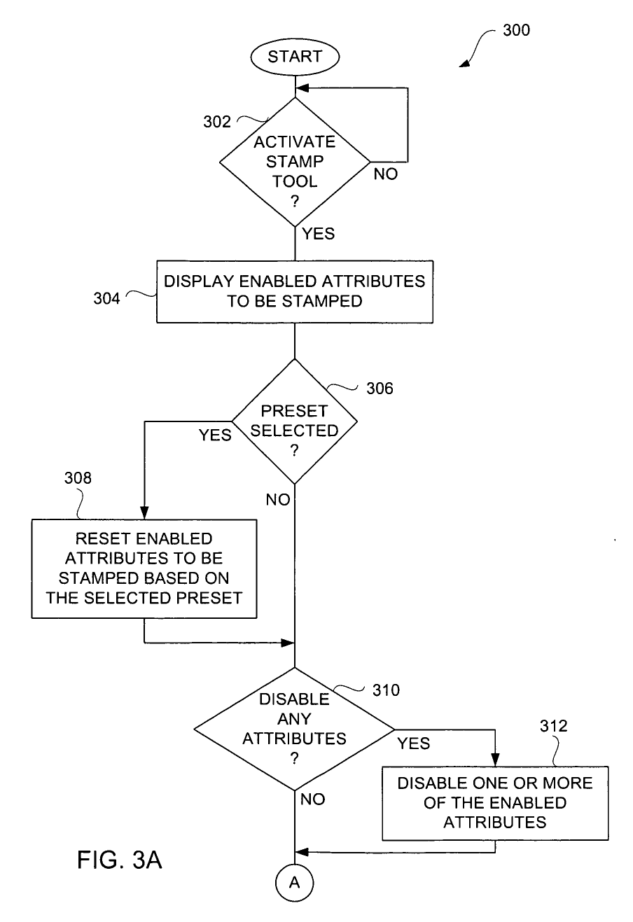

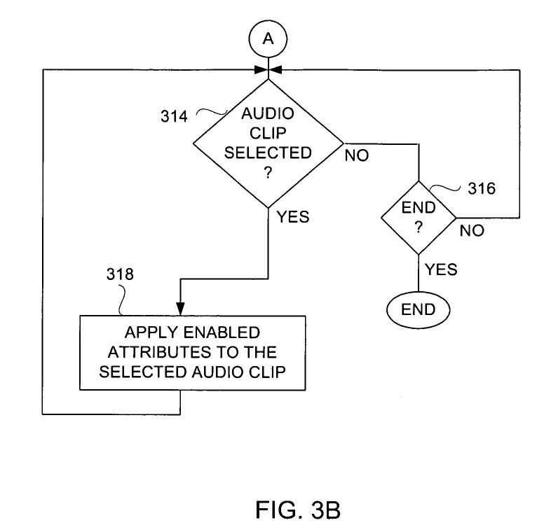

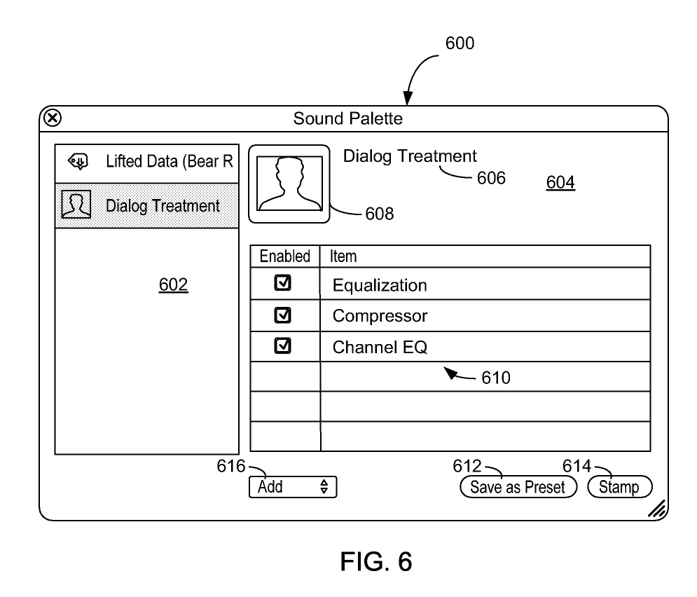

FIGS. 3A and 3B are flow diagrams of a stamp tool process 300 according to one embodiment of the invention. The stamp tool process 300 is, for example, performed by a computing device. The stamp tool process 300 typically follows the lift tool process 200 illustrated in FIG. 2. Alternatively, the stamp tool process 300 could follow a selection of a preset from a preset list (e.g., sound palette illustrated in FIG. 6). The stamp tool process 300 is utilized to apply previously lifted attributes from one audio clip to one or more audio clips.

The stamp tool process 300 can begin with a decision 302 that determines whether a stamp tool has been activated. When the decision 302 determines that a stamp tool has not been activated, the stamp tool process 300 can await activation of a stamp tool. Once the decision 302 determines that a stamp tool has been activated, enabled attributes to be stamped can be displayed 304. In addition, a decision 306 determines whether a preset has been selected. Here, the user of the stamp tool can continue with the enabled attributes being displayed 304, or the user can elect to select a previously stored set of attributes known as a preset. When the decision 306 determines that a preset has been selected, the enabled attributes to be stamped are reset 308 based on the select preset. In this regard, the enabled attributes of the selected preset are displayed.

Following the block 308 or directly following the decision 306 when a preset is not selected, a decision 310 determines whether any attributes are disabled. In one embodiment, the stamp tool allows a user to disable any of the attributes associated with the selected preset or those lifted from the source audio clip. When the decision 310 determines that one or more attributes are to be disabled, then one or more of the enabled attributes can be disabled 312.

Following the block 312 or directly following the decision 310 when none of the attributes are being disabled, a decision 314 determines whether an audio clip has been selected. Here, the selection of an audio clip is the selection of a destination for the enabled attributes. Hence, when the decision 314 determines that there is no selected audio clip, a decision 316 determines whether the stamp tool process 300 should end. When the decision 316 determines that the stamp tool process should end then the stamp tool process 300 ends. Alternatively, when the decision 316 determines that the stamp tool process 300 should not end, the stamp tool process 300 returns the repeat the decision 314. Once the decision 314 determines that an audio clip, namely, a destination audio clip, has been selected, the enabled attributes can be applied 318 to the selected audio clip. Following the block 318, the stamp tool process 300 returns to repeat the decision 314 so that additional audio clips can be selected and have the enabled attributes applied. In one implementation, the enabled attributes can be applied to an entire track, clip or file. In another implementation, the enabled attributes can be applied to a portion of a track, clip or file.

The lift and stamp processes discussed above can be facilitated by a graphical user interface. In one embodiment, the graphical user interface can be referred to as a sound palette.

FIG. 4 illustrates an exemplary sound palette dialog 400 according to one embodiment of the invention. The sound palette dialog 400 can be a graphical user interface displayed by a computing device performing sound production with respect to audio clips. The sound palette 400 includes a preset (or template) region 402 that lists any presets (or templates) that have been established. As illustrated in FIG. 4, two presets have been previously established, one denoted “Excite and Compress” and the other denoted “Reverb It”. In FIG. 4, the “Excite and Compress” preset has been selected in the preset region 402. Hence, a preset identification region 403 provides a name 404 as well as an image 406 for the selected preset. An attribute region 408 displays the one or more attributes that are associated with the selected preset. These attributes are named “Compressor”, “Exciter” and “Space Designer,” respectively. Each of the attributes in the attribute region 408 can be separately enabled or disabled.

The sound palette dialog 400 can also includes a number of controls that assist the user with various operations. A “Save as Preset” control 410 can allow the user to save the set of attributes enabled in the attribute region 408 as a new preset (or template). A stamp control 412 can enable a user to apply the set of attributes associated with the selected preset to a destination audio clip. A control 414 allows a user to cause the attributes to be applied differently to the destination audio clip. For example, the control 414 can allow the attributes to “added” to those attributes already associated with destination audio clip. Alternatively, the control 414 can allow the attributes to replace those attributes associated with the destination audio clip.

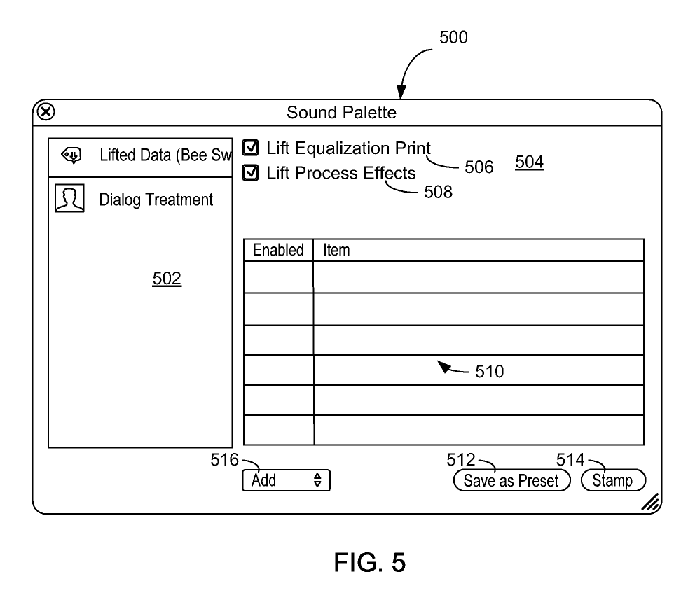

FIG. 5 is an exemplary sound palette dialog 500 according to one embodiment of the invention. The sound palette dialog 500 illustrated in FIG. 5 corresponds to a graphical user interface associated with a lift tool. The sound palette dialog 500 includes a preset (or template) region 502 that lists one or more available presets (or templates). A lift control region 504 lists different types of attributes that can be lifted from a source audio clip. In the example illustrated in FIG. 5, the attributes are categorized as “Equalization Print” 506 and “Process Effects” 508. A user can interact with the sound palette dialog 500 to disable either or both of the “Equalization Print” 506 and “Process Effects” 508. To the extent these attributes are disabled, when lifting attributes from a source audio clip, the disabled attributes or categories thereof will not be lifted. The sound palette dialog 500 also includes an attribute region 510. The attribute region 510 lists the particular attributes that have been lifted from a source audio clip. As illustrated in FIG. 5, there are no attributes being displayed since the user is assumed not to have already selected a particular source audio clip from which to lift attributes. The sound palette dialog 500 also includes a “Save as Preset” control 512 that is disabled since there are no attributes in the attribute region 510. The sound palette dialog 500 also includes a stamp control 514 that assists the user in applying listed attributes to a destination source clip. The sound palette dialog 500 further includes a control 516 that enables the user to control the manner in which the attributes are applied to the destination source clip. The use of the stamp control 514 and the control 516 are discussed in more detail below with respect to FIG. 6. Once an audio clip is selected from which attributes are to be lifted, those attributes or categories that are enabled in the lift control region 504 are acquired from the selected audio clip. When such occurs, the attribute region 510 of the sound palette dialog 500 can display the lifted attributes.

FIG. 6 is an exemplary sound palette window 600 according to one embodiment of the invention. The sound palette dialog 600 pertains to a template or preset entitled “Dialog Treatment”. The sound palette dialog 600 includes a preset (or template) region 602. The preset region 602 indicates that the preset referred to a “Dialog Treatment” has been selected. An identification region 604 can then display the name 606 and/or an image 608 associated with the selected preset. An attribute region 610 can display the one or more attributes associated with the selected preset. Each of the attributes in the attribute region 610 can be individually enabled or disabled. In this regard, different combinations of attributes can be enabled and, if desired, different combinations can be saved as additional presets (or templates) using a “Save as Preset” control 612. In addition, a stamp control 614 can enable a user to apply the enabled attributes associated with the selected preset to a destination audio clip. A control 616 can be utilized to determine whether the attributes being applied to a destination audio clip are to be added to the existing attributes for the destination audio clip or are to replace the existing attributes of the destination audio clip.

Although the sound palettes discussed above can be used to apply particular attributes to a destination audio clip, in one embodiment a “paint” tool can be used to apply attributes to one or more audio clips in whole or in part as specified by the “paint” tool. Also, in one embodiment, a lift tool can be an eyedropper-like tool that is used to extract (i.e., lift) attributes from an audio clip and provide them to a sound palette.

Further, although the above discussion primarily discusses copying (e.g., lifting) and applying (e.g., stamping) audio effects to from one digital media asset segment to another, the embodiments of the invention can also be used for lifting and applying color properties, video effects or image processing operations.

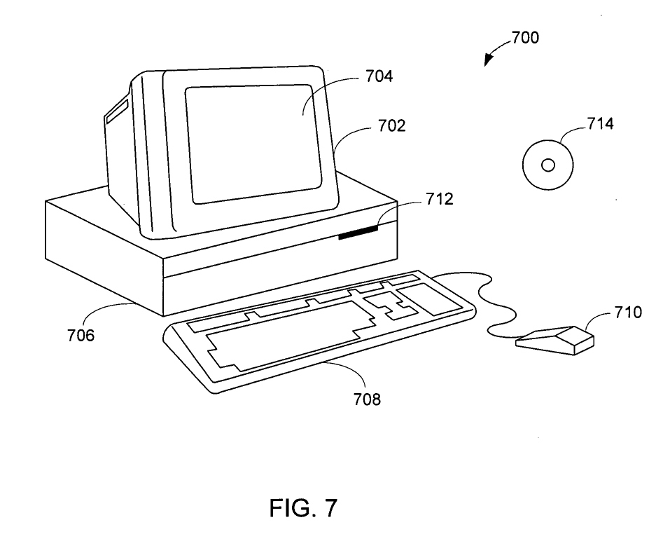

FIG. 7 shows an exemplary computer system 700 suitable for use with the invention. The methods, processes and/or graphical user interfaces discussed above can be provided by a computer system. The computer system 700 includes a display monitor 702 having a single or multi-screen display 704 (or multiple displays), a cabinet 706, a keyboard 708, and a mouse 710. The cabinet 706 houses a processing unit (or processor), system memory and a hard drive (not shown). The cabinet 706 also houses a drive 712, such as a DVD, CD-ROM or floppy drive. The drive 712 can also be a removable hard drive, a Flash or EEPROM device, etc. Regardless, the drive 712 may be utilized to store and retrieve software programs incorporating computer code that implements some or all aspects of the invention, data for use with the invention, and the like. Although CD-ROM 714 is shown as an exemplary computer readable storage medium, other computer readable storage media including floppy disk, tape, Flash or EEPROM memory, memory card, system memory, and hard drive may be utilized. Additionally, a data signal embodied in a carrier wave (e.g., in a network) may be the computer readable storage medium. In one implementation, a software program for the computer system 700 is provided in the system memory, the hard drive, the drive 712, the CD-ROM 714 or other computer readable storage medium and serves to incorporate the computer code that implements some or all aspects of the invention.

Additional details on media production are contained in: (i) U.S. patent application Ser. No. 11/735,468, filed Apr. 14, 2007, and entitled “MULTI-TAKE COMPOSITING OF DIGITAL MEDIA ASSETS,” which is hereby incorporated herein by reference; (ii) U.S. Provisional Patent Application No. 60/911,886, filed Apr. 14, 2007, and entitled “MULTIPLE VERSION MERGE FOR MEDIA PRODUCTION,” which is hereby incorporated herein by reference; and (iii) U.S. patent application Ser. No. 11/735,466, filed Apr. 14, 2007, and entitled “MULTI-FRAME VIDEO DISPLAY METHOD AND APPARATUS,” which is hereby incorporated herein by reference.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that attributes for media content can be managed. For example, attributes from one digital media asset can be copied and saved and thereafter applied to other digital media assets in an efficient, user-friendly manner. Another advantage of the invention is that attribute sets can be stored as templates or presets so that they can be subsequently recalled and utilized. Still another advantage of the invention is that the attributes can be analysis items that require an analysis of a source digital asset and/or a destination media asset when being applied to the destination media asset.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for applying attributes to a digital media asset, said method comprising:
receiving a first user request to copy a determined set of attributes associated with a first digital media asset;
copying the determined set of attributes from the first digital media asset to memory storage in response to the received first user request;
receiving a second user request to apply at least one of the attributes within the determined set of attributes to a second digital media asset; and
applying the at least one of the attributes within the determined set of attributes stored in the memory storage to the second digital media asset in response to the received second user request.

2. A method as recited in claim 1, wherein said method comprising:
limiting one or more attributes of the determined set of attributes that are to be applied to the second digital media asset.

3. A method as recited in claim 1, wherein said method comprises:
displaying a list of attributes that are included within the determined set of attributes;
receiving a user selection to disable one or more of the attributes being displayed in the list; and
disabling one or more of the attributes in accordance with the user selection,
wherein said applying of the at least one of the attributes within the determined set of attributes to the second digital media asset operates to apply only those of the one or more attributes of the determined set of attributes that are not disabled.

4. A method as recited in claim 1, wherein the determined set of attributes being copied by said copying are only a subset of available attributes for the first digital media asset.

5. A method as recited in claim 1, wherein said copying comprises:
displaying a list of attributes;
receiving a user selection to disable one or more of the attributes being displayed in the list; and
disabling one or more of the attributes in accordance with the user selection, thereby forming a revised set of attributes.

6. A method as recited in claim 5, wherein said copying further comprises:
receiving a user selection to save the revised set of attributes to the memory storage; and
saving the revised set of attributes to the memory storage for subsequent retrieval.

7. A method as recited in claim 6, wherein said saving of the revised set of attributes identifies the revised set in accordance with an assigned name.

8. A method as recited in claim 1, wherein said applying comprises:
receiving a user application input to designate whether the at least one of the attributes associated with the determined set of attributes are to be applied in place of or in addition to existing attributes of the second digital media asset; and
applying, in response to the user application input, the at least one of the attributes within the determined set of attributes to the second digital media asset, whereby the at least one of the attributes associated with the within the determined set of attributes are applied to the second digital media asset in place of or in addition to existing attributes of the second digital media asset based on the user application input.

9. A method as recited in claim 1, wherein the first digital media asset is a first audio segment, and wherein the second digital media asset is a second audio segment.

10. A method as recited in claim 1, wherein the determined set of attributes includes at least one attribute that is a processing operation or effect associated with the first digital media asset.

11. A method as recited in claim 1, wherein said method further comprises:
receiving a subsequent user request to apply at least one of the attributes within the determined set of attributes to a third digital media asset; and
applying the at least one of the attributes within the determined set of attributes to the third digital media asset in response to the received subsequent user request.

12. A method as recited in claim 1, wherein the determined set of attributes includes at least one analysis-type attribute that involves analysis of the first digital media asset.

13. A method as recited in claim 12, wherein the analysis-type attribute can provide equalization matching, voice matching, level matching or ambience matching for the second digital media asset.

14. A method as recited in claim 13, wherein said applying of the analysis-type attribute to the second digital media asset comprises:
analyzing the second digital media asset to obtain analysis data; and
performing a function (f) on the analysis data based on the second digital media asset and on the analysis data.

15. A method as recited in claim 12, wherein said method further comprises:
analyzing the first digital media asset to obtain the at least one analysis-type attribute.

16. A method as recited in claim 1, wherein said method further comprises
analyzing the first digital media asset to obtain at least one analysis result; and
storing the analysis result to the memory storage.

17. A method as recited in claim 1, wherein the determined set of attributes includes at least one process-type attribute.

18. A method as recited in claim 1, wherein the determined set of attributes includes at least one administrative attribute.

17. A method for applying attributes to a media segment, said method comprising:
displaying a lift tool for lifting attributes from digital media segments;
determining a set of attributes to be lifted;
receiving a selection of a source media segment;
lifting attributes from the selected source media segment in accordance with the determined set of attributes that are enabled;
subsequently displaying a stamp tool;
receiving a selection of a destination media segment; and
applying the lifted attributes to the destination media segment.

18. A method as recited in claim 17,
wherein the stamp tool displays a list of the lifted attributes.
wherein the stamp tool permits any of the lifted attributes to be disabled, and
wherein said applying applies those of the lifted attributes that are enabled to the destination media segment.

19. A method as recited in claim 17, wherein the stamp tool permits the lifted attributes to be stored as a recallable template.

20. A method as recited in claim 17,
wherein the stamp tool permits designation of whether the lifted attributes are to be applied in place of or in addition to existing attributes of the destination media segment, and
wherein said applying operates to apply the lifted attributes to the source media segment in accordance with the designation of whether the lifted attributes are to be applied in place of or in addition to existing attributes of the destination media segment.

21. A method as recited in claim 17, wherein the determined set of attributes is determined based on those attributes that are enabled based on user preferences.

22. A method as recited in claim 17, wherein the source media segment and the destination media segment are audio segments.

23. A computing device, comprising:
an user input device configured to receive user inputs;
a memory storage device configured to access at least
computer program code for determining that a user input pertains to a first user request to copy a determined set of attributes associated with a first digital media asset;
computer program code for copying the determined set of attributes from the first digital media asset to said memory storage device in response to the first user request;
computer program code for receiving a second user request to apply at least one of the attributes within the determined set of attributes to a second digital media asset; and
computer program code for applying the at least one of the attributes within the determined set of attributes stored in said memory storage device to the second digital media asset in response to the second user request; and
a processing device configured to execute the computer program code stored in said memory storage device.

24. A graphical user interface for display on a display associated with a computing device, said graphical user interface comprising:
a name for a set of audio properties;
a listing of each of the audio properties;
a disable control for each of the audio properties; and
an apply control for initiating application of those of the audio properties that are not disabled to an audio segment.

25. A graphical user interface as recited in claim 24, wherein said graphical user interface is an audio properties replication tool.

26. A graphical user interface as recited in claim 24, wherein said graphical user interface further comprises:
an add/replace control that is used to designate whether the audio properties should replace or add to other existing properties of the audio segment.

27. A graphical user interface as recited in claim 24, wherein said graphical user interface further comprises:
an image representing the set of audio properties; and
a save control that is user to save those of the audio properties that are not disabled as a template.

28. A computer readable storage medium including at least executable computer program code tangibly stored thereon for applying attributes to a digital media asset, said computer readable medium comprising:
computer program code for receiving a request to copy a determined set of attributes associated with a first digital media asset;
computer program code for copying attributes from the first digital media asset in response to the received request;
computer program code for receiving a request to apply at least one of the copied attributes to a second digital media asset; and
computer program code for applying the at least one of the copied attributes to the second digital media asset in response to the received request.

29. A computer readable storage medium including at least executable computer program code tangibly stored thereon for applying attributes to a digital asset segment, said computer readable medium comprising:
computer program code for displaying a first tool for capturing attributes from digital asset segments;
computer program code for determining a set of attributes to be captured;
computer program code for receiving a selection of a source digital asset segment;
computer program code for capturing attributes from the selected source digital asset segment in accordance with the determined set of attributes that are enabled;
computer program code for subsequently displaying a second tool;
computer program code for receiving a selection of a destination digital asset segment; and
computer program code for applying the captured attributes to the destination digital asset segment.
